(19) United States
(12) Patent Application Publication
(10) Pub. No.: US 2019/0127210 A1
(43) Pub. Date: May 2, 2019

(54) TANK OVERFLOW RISK MITIGATION SYSTEM

(71) Applicant: BAKER ENGINEERING & RISK CONSULTANTS, INC., San Antonio, TX (US)

(72) Inventor: James Kelly THOMAS, San Antonio, TX (US)

(21) Appl. No.: 16/173,445

(22) Filed: Oct. 29, 2018

Related U.S. Application Data
(60) Provisional application No. 62/578,828, filed on Oct. 30, 2017.

(51) Int. Cl. B67D 7/36; B67D 7/04

(52) U.S. Cl. CPC B67D 7/362; B67D 7/0492; B67D 7/048

(57) ABSTRACT

An overflow risk mitigation system for a large aboveground liquid storage tank includes a conduit mounted to an outside of the storage tank and extending from an overflow release port disposed in an upper portion of the storage tank to a lower portion of the storage tank. The conduit is closed and channels liquid overflow from the tank to a ground level while minimizing the production of mist or aerosol. The conduit can extend substantially vertically downward from the overflow release port, can have a cross sectional area substantially larger than that of the overflow release port and that expands downwardly from the release port, and can include a diffusive media at an outlet thereof. The overflow release port may be one of a plurality of release ports disposed at a same elevation around a periphery of the tank to allow for flow of liquid exceeding a maximum storage level.

### CROSS-REFERENCE TO RELATED APPLICATION

This application claims the benefit of U.S. Provisional Patent Application No. 62/578,828, filed on Oct. 30, 2017, in the U.S. Patent and Trademark Office, the disclosure of which is incorporated by reference herein in its entirety.

### TECHNICAL FIELD

The present subject matter relates to techniques and equipment to mitigate risks associated with overflow from storage tanks such as those used for storing volatile liquid substances.

### BACKGROUND

The overflow of gasoline or other volatile substances from a large aboveground storage tank (AST) through overflow vents located near or on the tank top can produce a “waterfall” (i.e., a high flow rate of liquid falling freely through the air outside of the tank), which greatly enhances the generation of mist and aerosol. Such tanks are generally large (e.g., million gallons or more), have either floating or fixed roof structures, and may be filled at significant volumetric flow rates (i.e., 1000 gpm or more) such that an overflow event can release a significant flow rate. The overflow for such a tank may be an open vent near or on the tank top, or can be a normally closed vent (i.e., a pressure relief/vacuum breaker valve).

The overflow of the volatile substance through the vent system of the AST can lead to the creation of a very large flammable vapor cloud through the production of a waterfall of the volatile substance outside of the tank. In particular, the vapor cloud may be very large relative to that created by evaporation of the liquid accumulated within the diked area surrounding the tank. If ignited, a large vapor cloud can pose significant flash fire and vapor cloud explosion (VCE) hazards. Absent the waterfall action, the overflow would only create a liquid pool within the diked storage area around the tank, which would create a much smaller flammable vapor cloud, and hence pose much smaller flash fire and vapor cloud explosion hazards.

Several large accidental VCEs have occurred due the discharge of gasoline through the tank overflow vents (e.g., the Buncefield fire, the CAPECO fire, etc.). The mist/aerosol generation mechanism associated with a gasoline tank overflow and the resulting hazards have been observed. The conventional approach to addressing this hazard is to attempt to increase the reliability of the tank liquid level instrumentation and control system (i.e., to reduce the frequency of storage tank overfill incidents to a tolerable level). However, the conventional approach cannot address failures in the tank liquid level instrumentation and control.

The tank overflow risk mitigation system (TOMS) presented herein provides a fundamentally different and complementary approach by which the consequences of a storage tank overfill incident are greatly reduced. Combined with a reasonably reliable tank liquid level instrumentation and control system, the tank overflow risk mitigation system presented herein allows the risks associated with storage tank overfill incidents to be reduced to a very low level.

### SUMMARY

The teachings herein alleviate one or more of the above noted problems with the overflow of liquids from storage tanks such as those used for storing volatile substances.

In accordance with certain aspects of the present disclosure, a tank overflow risk mitigation system including a conduit mounted to an outside of a liquid storage tank having a plurality of overflow release ports disposed in an upper portion of the liquid storage tank, the conduit extending between one of the plurality of overflow release ports and a lower portion of the liquid storage tank.

The conduit may extend substantially vertically downward from the one overflow release port along an outer surface of the liquid storage tank.

The conduit may have an upper portion located proximate to the one overflow release port and a lower portion proximate to the lower portion of the liquid storage tank, and a cross sectional area of the lower portion of the conduit may be larger than a cross sectional area of the upper portion of the conduit. The cross sectional area of the lower portion of the conduit may be at least 3 times larger than the cross sectional area of the upper portion of the conduit.

The one overflow release port may extend through a wall of the liquid storage tank and may allow for flow of stored liquid exceeding a maximum storage level for the liquid storage tank, and the conduit may direct the flow of the stored liquid exceeding the maximum storage level to a ground level outside of the liquid storage tank.

The tank overflow risk mitigation system may further include a plurality of conduits including the conduit, each conduit of the plurality of conduits extending between a respective one of the plurality of overflow release ports and the lower portion of the liquid storage tank. Each of the plurality of overflow release ports may be disposed at a same height as each other in the upper portion of the liquid storage tank, and each conduit may extend from one of the overflow release ports disposed at the same height as each other. A conduit may be included for each overflow release port of the plurality of overflow release ports of the liquid storage tank.

The conduit may have a cross sectional area larger than an area of the one overflow release port. The conduit may have a minimum cross sectional area at least 50% larger than an area of the one overflow release port.

The conduit may include a three-sided structure attached to the outside of the liquid storage tank and forming a four-sided conduit for liquid flow using the three-sided structure and an outside surface of the liquid storage tank.

The conduit may include a four-sided structure attached to the outside of the liquid storage tank.

The tank overflow risk mitigation system may further include a diffusive media disposed at an outlet of the conduit adjacent to the lower portion of the liquid storage tank. The diffusive media may be disposed within the conduit and may include rocks of varying sizes.

The conduit may include a grating at an outlet thereof disposed adjacent to the lower portion of the liquid storage tank, and the diffusive media may be disposed on an inside of the conduit and of the grating. The diffusive media disposed adjacent to an outlet of the conduit may have an average size larger than diffusive media disposed further from the outlet of the conduit.

The tank overflow risk mitigation system may further include an access hatch providing access inside the conduit along the outside of the liquid storage tank. The access hatch may be disposed between 3 and 5 feet above a lower extremity of the conduit and may have at least one dimension of 1 foot or larger.

The tank overflow risk mitigation system may further include a tube connected to the conduit and extending upward from the one overflow release port. The tube may extend between 4 and 8 feet upward from the one overflow release port.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a high-level functional diagram of a large aboveground storage tank (AST) having an integrated tank overflow mitigation system.

FIGS. 2A and 2B show cross-sectional views of the tank and overflow conduit according to various embodiments of the tank overflow mitigation system of FIG. 1.

FIGS. 3A, 3B, 3C, 3D, and 3E show detailed views of different elements of the various embodiments of the tank overflow mitigation system of FIG. 1.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The various systems disclosed herein relate to the mitigation of risks associated with overflow from storage tanks such as those used for storing volatile liquid substances. To mitigate such risks, a tank overflow mitigation system (TOMS) controls the discharge of the liquid from the tank in the event of an overflow in such a way that the generation of mist and aerosol is essentially precluded or substantially reduced, and such that any mist and aerosol that is created is contained. The TOMS also precludes or reduces the energetic liquid discharge at grade level, such that the released liquid flows into the diked area without generating mist or aerosol. The TOMS thereby limits the size of any flammable cloud resulting from the liquid discharge such that any resulting flammable cloud is not substantially larger that a flammable could which would be generated by pool evaporation and such that any resulting flammable cloud poses a comparatively small flash fire and/or VCE hazard.

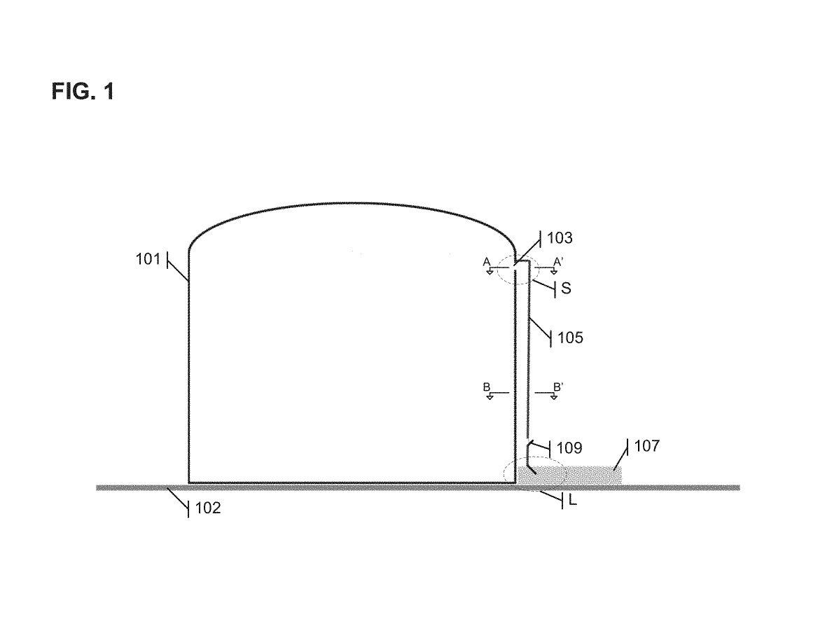

FIG. 1 shows an illustrative storage tank having a tank overflow mitigation system (TOMS) mounted thereon. As shown, the tank 101 may be a large aboveground storage tank (AST) that extends at least in part above a ground plane 102. The tank 101 can optionally include an in-ground portion that extends below the ground plane 102, and will extend at least in part above ground as shown in FIG. 1.

The tank 101 includes at least one overflow release port 103, and can include a plurality of overflow release ports 103 around its periphery. The overflow release port 103 is an opening or conduit extending through a wall of the tank 101 and is provided to ensure that a level of liquid stored in the tank 101 does not exceed a maximum storage level for the tank 101. For this purpose, a lower edge of the overflow release port 103 is positioned in some embodiments to be level with the maximum storage level for the tank 101 such that any liquid volume extending above the maximum storage level can flow freely through the overflow release port 103 to thereby ensure that the tank 101 cannot be overfilled over the maximum storage level. While a single overflow release port 103 is illustratively shown in FIG. 1 for simplicity, a storage tank 101 according to the disclosure will have multiple overflow release ports 103 disposed around its periphery. Additionally, each of the overflow release ports 103 provided in a same tank 101 are positioned at a substantially same level or elevation (e.g., a substantially same level or elevation measured relative to horizontal plane orthogonal to gravity) corresponding to the maximum storage level for the tank 101 such that a level of liquid stored in the tank 101 will substantially concurrently reach all overflow release ports 103 when the tank reaches its capacity or is overfilled. In some embodiments, the overflow release port(s) 103 may be referenced as a vent(s) and may serve the function of overflow release port(s) such as those described above.

To provide tank overflow mitigation, the tank 101 further includes an overflow conduit 105 positioned on an exterior of the tank 101 and extending from the overflow release port 103 to the ground level 102. The overflow conduit 105 is a substantially closed conduit and provides a closed channel for the flow of any liquid flowing out of and through the corresponding overflow release port 103. In embodiments in which a tank 101 includes multiple overflow release ports 103, an overflow conduit 105 such as that shown in FIG. 1 is provided for each overflow release port 103.

In the illustrative embodiment of FIG. 1, the overflow release ports 103 are disposed on and extend through a side wall or side surface of the tank 101. In some embodiments, the overflow release ports 103 are disposed on a roof of the tank 101 or other surface of the tank 101 to extend from an interior of the tank to an exterior of the tank, and the overflow conduit(s) 105 extend from each overflow release port 103 located on the roof or other surface of the tank 101.

The overflow conduit 105 serving as a TOMS includes a conduit, channel, gutter, downspout, pipe, or the like that is attached to the tank 101 at each overflow release port 103 location. The conduit channels any liquid flow from the overflow release port 103 to grade or ground level 102 and thereby prevents the liquid from forming an unconfined waterfall along an exterior of the tank 101.

In various embodiments, the overflow release port 103 has a width w_{d} and a height h_{d} in the range of 2 cm to 150 cm. In various embodiments, the overflow conduit 105 has a width w_{c} (e.g., a dimension measured orthogonally to the tank wall) in the range of 5 cm to 100 cm, a length l_{c} (e.g., a dimension measured parallel to the tank wall in a horizontal direction) in the range of 5 cm to 200 cm, and a height (e.g., a dimension measured parallel to the tank wall in a vertical direction) in the range of 1 m to 50 m.

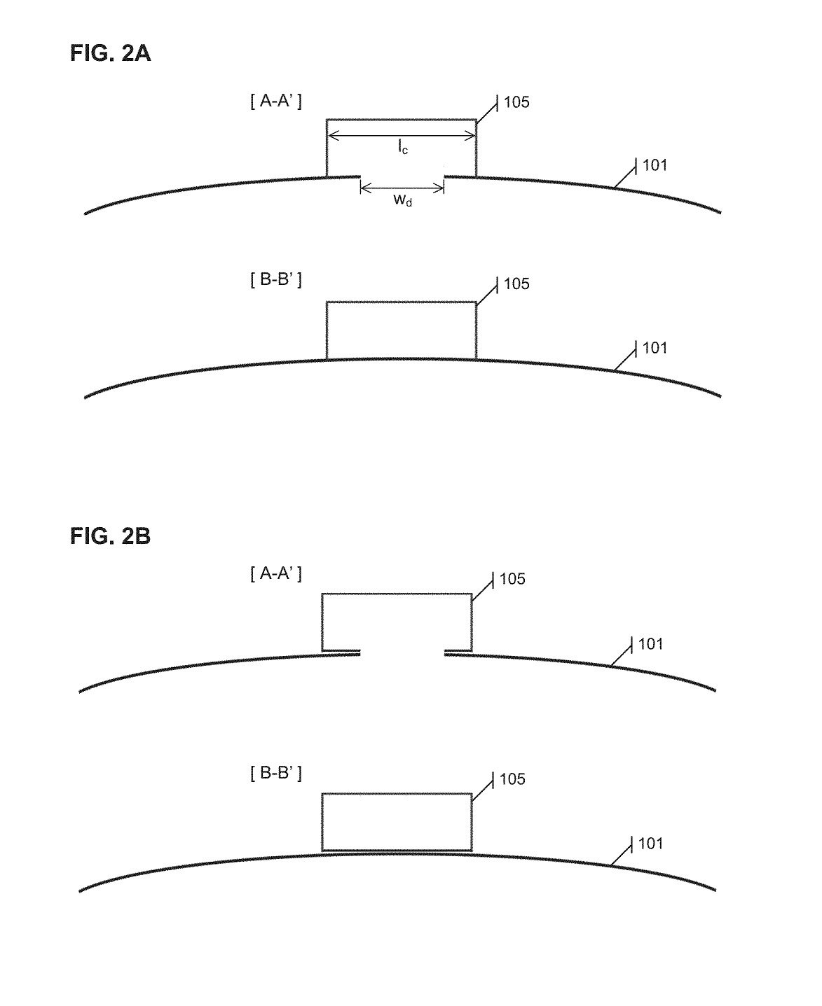

FIGS. 2A and 2B show top-down cross-sectional views of the storage tank of FIG. 1 along lines A-A′ and B-B′ for two distinct embodiments of the overflow conduit 105. In FIG. 2A, cross-sectional views along lines A-A′ and B-B′ are shown for a first embodiment in which the overflow conduit 105 has a three-sided or open structure that makes use of the side surface of the tank 101 to form a closed channel. In FIG. 2B, cross-sectional views along lines A-A′ and B-B′ are shown for a second embodiment in which the overflow conduit 105 has a four-sided or closed structure that includes a surface contacting the side surface of the tank 101.

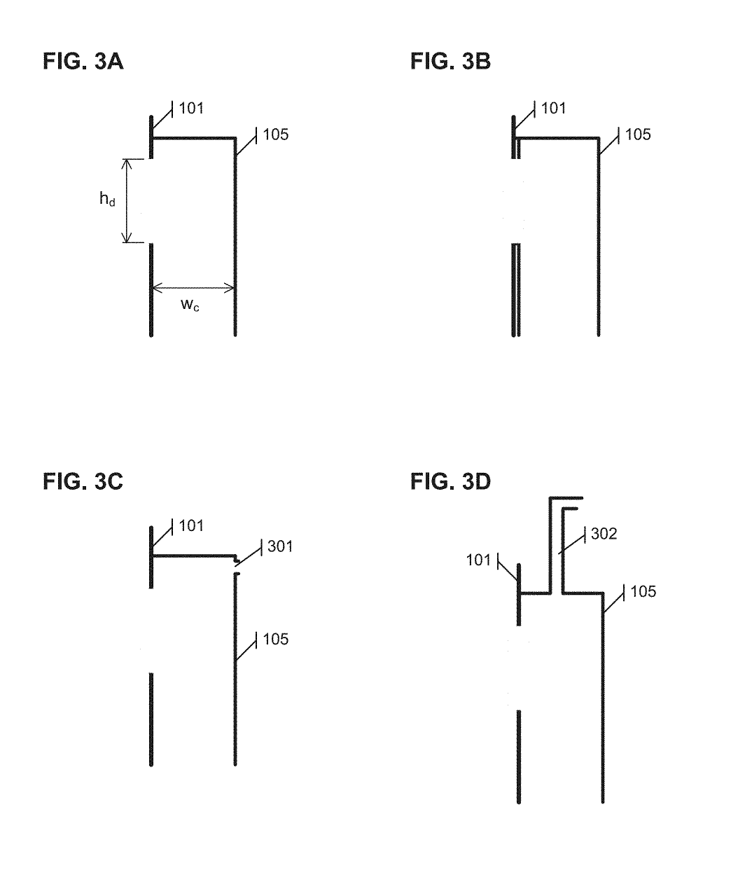

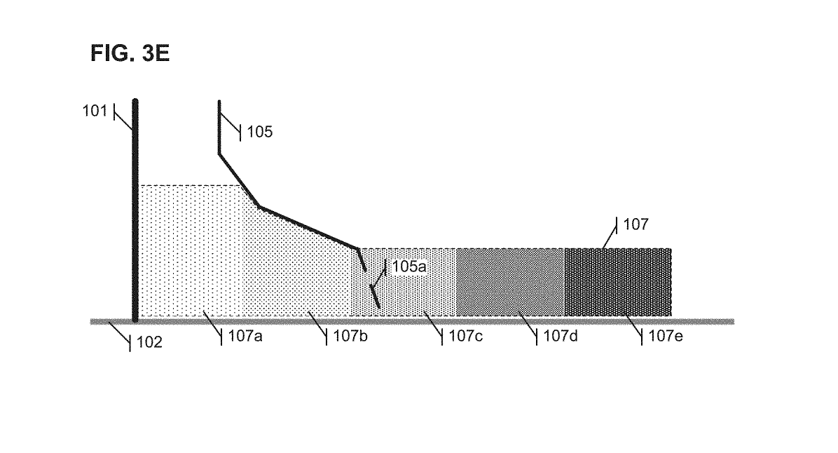

FIG. 3A shows a detailed views of the area S identified in the side cross-sectional view of FIG. 1 in the case of the first embodiment, and FIG. 3B shows a detailed views of the area S in the case of the second embodiment. FIG. 3A further illustratively shows the height h_{d} and width w_{c} measurements, respectively of the substantially rectangular release port 103 and of the overflow conduit 105 depicted in the figure, while FIG. 2A illustratively shows the width w_{d} and length l_{c} measurements, respectively of the substantially rectangular release port 103 and overflow conduit 105 depicted in the figure. Moreover, while the release port 103 and overflow conduit 105 are illustratively depicted in the figures as having substantially rectangular cross sections, the release port and overflow conduit can have other cross-sectional shapes including substantially square, round, oval, hexagonal, octagonal, or the like cross sections.

The overflow conduit 105 has a cross sectional area that is larger (e.g., 50% to 100% larger) than a cross sectional area of the overflow release port 103, so that presence of the overflow conduit 105 does not significantly increase the hydraulic resistance of liquid flow through the overflow release port 103 (e.g., does not restrict fluid flow through the overflow conduit 105). In the embodiment depicted in the figures, a cross sectional area of the substantially rectangular overflow conduit 105 may be measured as w_{c}*l_{c}, although a different appropriate measure of cross sectional area can be used in embodiments in which the overflow conduit 105 is not rectangular. Similarly, a cross sectional area of the substantially rectangular release port 103 may be measured as w_{d}*h_{d}, although a different appropriate measure of cross sectional area can be used in embodiments in which the release port 103 is not rectangular. In cases in which the overflow conduit 105 has a variable cross sectional area (for example in embodiments in which a cross sectional area of the overflow conduit 105 increases in a lower portion of the overflow conduit 105 closer to the ground plane 102), the minimum cross sectional area of the overflow conduit 105 (which may correspond to the cross sectional area of a portion of the overflow conduit 105 proximate to the release port 103) may be larger (e.g., 50% to 100% larger) than the cross sectional area of the overflow release port 103.

The overflow conduit 105 is physically attached and sealed to the tank 101 at the overflow release port 103, such that fluid discharged through the release port 103 must flow through the overflow conduit 105 and cannot get past/around the conduit 105. The overflow conduit 105 can be attached to the tank by bolting to brackets which are welded to the tank 101, or by welding the overflow conduit 105 directly onto the outer surface of the tank 101. The connection is preferably of sufficient strength to resist the hydraulic force exerted by the horizontal liquid flow from the release port 103 entering the overflow conduit 105 and being forced downward by gravity. The overflow conduit 105 is also attached to the tank 101 at discrete locations along the length of the tank 101 and overflow conduit 105 to ensure that the overflow conduit 105 cannot be displaced by the force associated with the downward liquid flow. The connections can be made either by brackets or by directly welding the overflow conduit 105 onto the tank 101.

For an existing storage tank 101 to which the overflow conduit 105 is being added, the overflow conduit 105 can have a backside (i.e., a side facing the tank) as depicted in FIGS. 2B and 3B, such that the overflow conduit 105 provides a channel structure having four sides. For overflow conduits 105 installed on new storage tanks 101, the overflow conduit 105 can be made three-sided, with the tank wall itself forming the fourth wall of the channel as depicted in FIGS. 2A and 3A. In this case, the conduit sides may be welded to the tank 101 down the length of the conduit. FIG. 2B show cross sections of an overflow conduit 105 designed for installation on an existing tank 101 (i.e., in which the overflow conduit 105 has four sides), with the upper figure A-A′ showing a cross section at the elevation of the overflow release port 103 and the lower figure B-B′ showing a cross section below elevation of the overflow release port 103. For tanks fitted with stiffener rings, wind girders, deflector plates, or other structures which protrude from the tank shell-roof joint, shell, or other outer or external surface, the overflow conduit 105 can either be stood away or off from the tank wall by a series of spacers, or can be “notched” to accommodate these devices. Alternatively, overflow conduits 105 can be mounted flush with a side surface of a tank 101, or can be spaced apart from the side surface provided that a conduit is provided to carry liquid flow from the overflow release port 103 to the conduit 105.

The tank overflow mitigation system (TOMS) can additionally include a structure at the exit or lower extremity of the overflow conduit 105 to slow the flow of liquid out of the overflow conduit 105. For example, as shown in FIGS. 1 and 3E, the TOMS can include a porous diffusive media 107 at the exit of the overflow conduit 105. The porous diffusive media 107 can include a rock bed or bed made of other suitable material that is disposed at the exit of the overflow conduit 105 such that liquid flowing out of the overflow conduit 105 is directed through the media 107. Further details of the lower extremity of the overflow conduit 105 is shown in FIG. 3E, which shows a detailed view of area L of FIG. 1.

Additionally, the exit or lower extremity of the overflow conduit 105 may have cross section that is made significantly larger than the cross-section of the main section of the overflow conduit 105, as shown in FIG. 3E, so as to decrease the hydraulic resistance of liquid flow in the exit section. The cross section of the exit or lower extremity may be made larger by a widening of the overflow conduit 105 in one or both of the length (e.g., l_{c}) and width (e.g., w_{c}) directions. In particular, the cross section can be made larger so as to increase flow area and thereby compensate for the hydraulic resistance of the porous diffusive media 107. For example the cross section of the overflow conduit 105 can be increased by a factor of 3 to 4 times (e.g., 3-4 times larger than a cross-section of a central or upper section of the overflow conduit 105). By providing the larger cross section at the exit, the overflow conduit 105 minimizes the occurrence of back-ups or accumulation of the flowing liquid in the overflow conduit 105 even at elevated flow rates.

The porous diffusive media 107 at the outlet of the overflow conduit 105 prevents the discharged fluid from exiting at high velocity in a coherent stream (e.g., spraying out) that may splash and generate mist or aerosols upon contact with an obstacle. In some embodiments, the diffusive media 107 extends up into the exit section of the overflow conduit 105, as shown at 107a-b in FIG. 3E, and is supported by a grated section 105a at an outlet of the overflow conduit 105. The diffusive media 107 further extends out and away from the outlet or exit section of the overflow conduit 105 for a distance of 3 to 10 feet, for example as shown at 107c-e in FIG. 3E, to ensure that the flow velocity of liquid exiting the diffusive media 107 is sufficiently low to prevent splashing.

The porous media 107 can include multiple different sections (e.g., 107a-e in FIG. 3E) sequentially placed along the flow path at the exit of the overflow conduit 105. For example, an initial section of the porous media 107, such as a section 107a located within the overflow conduit 105 or a section located directly following an exit of the overflow conduit 105, includes large objects (e.g., rocks) to reduce the associated hydraulic resistance and prevent displacement of the media 107 by the fluid flow. In further sections (e.g., 107d-e) of the porous media 107 that are located further from the exit of the overflow conduit 105, the object size or particle diameter of the porous media 107 can be decreased further along the flow path through the exit of the overflow conduit 105 and further away from the exit (e.g., several feet away) to further reduce flow velocity. In various embodiments, the porous media 107 includes rocks, crushed stone, gravel, and/or other aggregate with diameters in the range of 0.5 cm to 50 cm. In one illustrative example, one section (e.g., 107a) includes rocks with diameters in the range of 20 cm to 50 cm; another section (e.g., 107b) includes rocks with diameters in the range of 10 cm to 30 cm; another section (e.g., 107c) includes rocks with diameters in the range of 5 cm to 15 cm; another section (e.g., 107d) includes rocks with diameters in the range of 2 cm to 8 cm; and another section (e.g., 107e) includes rocks with diameters in the range of 0.5 cm to 5 cm.

The overflow conduit 105 can, in some examples, include an optional inspection port or hatch 109 near grade or ground level 102 (e.g., at 3 to 5 feet above grade or above an exit of the overflow conduit 105) to allow the interior of the conduit to be inspected periodically (e.g., yearly) to ensure it remains free of debris which could retard flow through the channel. The inspection port or hatch 109 is large enough in some embodiments such that an inspector can easily see inside the channel (e.g., 1 foot×1 foot hatch or larger). Multiple inspection hatches can be fitted along the length of the overflow conduit 105, e.g., at different elevations along the conduit. The inspection hatch 109 can also be used for supplying diffusive/porous media 109 into the conduit during installation of the TOMS. In some embodiments, the inspection hatch 109 can be opened for inspection, and in other embodiments, will remain in a closed or sealed position at other times to prevent splashing of liquid therethrough during a liquid overflow event.

An AST fitted with an overflow conduit 105 is optionally equipped with a vacuum breaker to ensure a vacuum is not drawn during an overflow event once the liquid addition is stopped (e.g., when the remainder of the fluid in the overflow conduit 105 drains out but no further flow of liquid is supplied to the overflow conduit 105 from overflow of the tank 101). An illustrative vacuum breaker in the form of an air intake vent 301 is illustratively shown in FIG. 3C. The air intake vent 301 provides a source of air at a top of the overflow conduit 105 to ensure that liquid flow through the overflow conduit 105 is not impeded by a vacuum forming in the overflow conduit 105. In this way, fluid flow is not restricted through the overflow conduit 105. As shown in FIG. 3C, the air intake vent 301 is located higher than a lower edge of the overflow release port 103, and is more commonly located higher than an upper edge of the overflow release port 103 to minimize chances of liquid flow through the air intake vent 301. The vacuum breaker can alternatively include a valve allowing air flow into the overflow conduit 105 while preempting the flow of liquid out of the overflow conduit 105, or take the form of an open tube 302 as shown in FIG. 3D that may be extended from the top of the overflow conduit 105 upward vertically to break the vacuum when liquid flow stops. The open tube 302 is preferably extended to a height sufficient for the liquid pressure at the top of the overflow conduit 105 not to force fluid out of the open tube 302 (e.g., a height of 4 to 8 feet above the liquid overflow release port 103).

Certain ASTs are inerted, such that air is excluded from the tank vapor space located between the upper surface of the liquid stored in the tank and the roof of the tank. For example, in inerted tanks, a non-reactive or inert gas is maintained in the tank vapor space. In the case of inerted tanks 101, the overflow release port 103 and/or the overflow conduit 105 may include a seal leg to prevent loss of the inert gas species from the tank vapor space.

In some examples, the AST includes a floating roof structure provided within the storage tank 101 and configured to move up and down in the storage tank 101. For example, the floating roof may move up and down in response to changes in the level of liquid stored in the tank 101. In tanks 101 that include floating roof structures, the TOMS (e.g. including the overflow release port 103 and the overflow conduit 105) is provided so as not to interfere with operation and movement of the floating roof within the tank 101. In particular, an inlet of the overflow release port 103 and the overflow conduit 105 is provided to be flush with an inside side surface or inside roof surface of the tank 101, and is provided so as not to extend within the tank 101. In this way, the overflow release port 103 and the overflow conduit 105 can receive and channel the overflow of liquid from the tank 101 without the TOMS coming into contact with the floating roof structure.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the tennis and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A tank overflow risk mitigation system, comprising:
a conduit mounted to an outside of a liquid storage tank having a plurality of overflow release ports disposed in an upper portion of the liquid storage tank, the conduit extending between one of the plurality of overflow release ports and a lower portion of the liquid storage tank.

2. The tank overflow risk mitigation system of claim 1, wherein the conduit extends substantially vertically downward from the one overflow release port along an outer surface of the liquid storage tank.

3. The tank overflow risk mitigation system of claim 1, wherein the conduit has an upper portion located proximate to the one overflow release port and a lower portion proximate to the lower portion of the liquid storage tank, and a cross sectional area of the lower portion of the conduit is larger than a cross sectional area of the upper portion of the conduit.

4. The tank overflow risk mitigation system of claim 3, wherein the cross sectional area of the lower portion of the conduit is at least 3 times larger than the cross sectional area of the upper portion of the conduit.

5. The tank overflow risk mitigation system of claim 1, wherein the one overflow release port extends through a wall of the liquid storage tank and allows for flow of stored liquid exceeding a maximum storage level for the liquid storage tank, and the conduit directs the flow of the stored liquid exceeding the maximum storage level to a ground level outside of the liquid storage tank.

6. The tank overflow risk mitigation system of claim 1, further comprising:
a plurality of conduits including the conduit, each conduit of the plurality of conduits extending between a respective one of the plurality of overflow release ports and the lower portion of the liquid storage tank.

7. The tank overflow risk mitigation system of claim 6, wherein each of the plurality of overflow release ports are disposed at a same height as each other in the upper portion of the liquid storage tank, and each conduit extends from one of the overflow release ports disposed at the same height as each other.

8. The tank overflow risk mitigation system of claim 6, wherein a conduit is included for each overflow release port of the plurality of overflow release ports of the liquid storage tank.

9. The tank overflow risk mitigation system of claim 1, wherein the conduit has a cross sectional area larger than an area of the one overflow release port.

10. The tank overflow risk mitigation system of claim 9, wherein the conduit has a minimum cross sectional area at least 50% larger than an area of the one overflow release port.

11. The tank overflow risk mitigation system of claim 1, wherein the conduit includes a three-sided structure attached to the outside of the liquid storage tank and forming a four-sided conduit for liquid flow using the three-sided structure and an outside surface of the liquid storage tank.

12. The tank overflow risk mitigation system of claim 1, wherein the conduit includes a four-sided structure attached to the outside of the liquid storage tank.

13. The tank overflow risk mitigation system of claim 1, further comprising a diffusive media disposed at an outlet of the conduit adjacent to the lower portion of the liquid storage tank.

14. The tank overflow risk mitigation system of claim 13, wherein the diffusive media is disposed within the conduit and includes rocks of varying sizes.

15. The tank overflow risk mitigation system of claim 14, wherein the conduit includes a grating at an outlet thereof disposed adjacent to the lower portion of the liquid storage tank, and the diffusive media is disposed on an inside of the conduit and of the grating.

16. The tank overflow risk mitigation system of claim 14, wherein the diffusive media disposed adjacent to an outlet of the conduit has an average size larger than diffusive media disposed further from the outlet of the conduit.

17. The tank overflow risk mitigation system of claim 1, further comprising an access hatch providing access inside the conduit along the outside of the liquid storage tank.

18. The tank overflow risk mitigation system of claim 17, wherein the access hatch is disposed between 3 and 5 feet above a lower extremity of the conduit and has at least one dimension of 1 foot or larger.

19. The tank overflow risk mitigation system of claim 1, further comprising a tube connected to the conduit and extending upward from the one overflow release port.

20. The tank overflow risk mitigation system of claim 19, wherein the tube extends between 4 and 8 feet upward from the one overflow release port.
